(19) United States
(12) Patent Application Publication
(10) Pub. No.: US 2017/0332173 A1
(43) Pub. Date: Nov. 16, 2017

(54) MAGNET SYSTEM FOR A LOUDSPEAKER, MAGNETIZING DEVICE, METHOD FOR PRODUCING A MAGNET SYSTEM AND LOUDSPEAKER

(71) Applicant: BLAUPUNKT EMBEDDED SYSTEMS GMBH, Schlitz (DE)

(72) Inventor: Norman GERKINSMEYER, Neu-Ulm (DE)

(21) Appl. No.: 14/652,100

(22) PCT Filed: Feb. 15, 2013
(86) PCT No.: PCT/EP2013/000451

§ 371 Date: Aug. 4, 2017

(30) Foreign Application Priority Data
Dec. 12, 2012 (DE) 10 2012 024 267.0

(51) Int. Cl. H04R 9/02; H04R 9/06

(52) U.S. Cl. CPC H04R 9/025; H04R 9/06

(57) ABSTRACT

The invention relates to a magnet system with at least one permanent magnet unit, in particular for use in a loudspeaker, wherein the permanent magnet unit consists of an interconnected combination of at least a first permanent magnet (5) having a first magnetic remanence and a second permanent magnet (4) having a second magnetic remanence, the second magnetic remanence being substantially higher, preferably at least twice as high as the first magnetic remanence.

The invention relates to a magnet system for a loudspeaker, a magnetizing device for such a magnet system, a method for producing a magnet system and a loudspeaker comprising such a magnet system.

Magnet systems having a predominantly ring-shaped air gap are generally known from the field of electromagnetic/dynamic sound transducers, actuators and exciters, but are also used in other types of electromagnetically driven systems having an air gap, such as e.g. motors, generators and drives which in the field concerning land, water and air.

In principle, the challenge repeatedly arises of reducing the size of the existing systems while maintaining the performance. For this purpose, in the case of magnet systems, recourse is increasingly being had to permanent-magnetic materials of particularly high performance, for example from the field of rare earths. The problem arises, however, that such magnet systems comprising so-called supermagnets having an extremely high magnetic remanence become very expensive.

It is an object of the invention to realize a magnet system of particularly small design which requires the smallest possible amounts of materials having particularly high magnetic remanence.

This object is achieved by means of the features of the independent patent claims. Dependent claims relate to advantageous developments of the invention.

The inventor has recognized that a magnet system constructed from a skillful combination of conventional ferrite material and a rare earth magnet, with the same structural size, attains virtually the same performance as can be achieved by a magnet system constructed purely from a rare earth magnet. In principle, this consideration according to the invention holds true for the combined use of permanent magnets that are expensive and of particularly high performance with inexpensive conventional permanent magnets of lower performance.

Magnet systems are conventionally equipped with only one type of magnet. In other words, either NdFeB=neodymium-iron-boron, or barium ferrite, Sm₂Co=samarium cobalt, strontium ferrite, AlNiCo magnet materials are used by themselves depending on the application, stipulations and budget.

If the existing system is then excessively weak, in general magnetic material is subsequently used, mounted, adhesively bonded or grouped. However, the additional magnets can be used only with considerable outlay, that is to say that both the existing magnets and the additionally used magnets are generally already magnetized and have to be mounted or adhesively bonded with opposite polarity in a repelling manner.

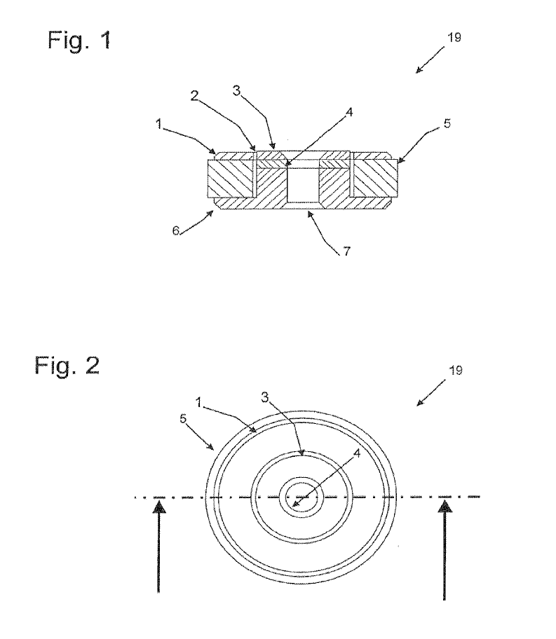

In this case, the overall system generally increases in terms of height (when viewed horizontally, see e.g. FIGS. 1 & 3), weight, costs and is significantly less effective compared with the multi-magnet according to the invention.

With comparable or higher field strength of a ferrite magnet comprising Y35 material, the multi-magnet according to the invention is more than 30% smaller but only insignificantly more expensive if the manner of construction according to the invention and the technical prerequisite of the magnetization or device according to the invention is taken into account.

In this regard, with the multi-magnet according to the invention, the specific properties of the different magnet materials can be combined with one another in a very targeted manner. One example: ferrite magnets have a significantly higher thermal stability but also volume requirement than e.g. NdFeB magnets. NdFeB magnets in turn have a significantly stronger field with significantly lower mass than ferrite magnets, but their thermal loading capacity is significantly lower.

It is proposed to use the higher mass of the ferrite as a heat sink or cooling mass for the NdFeB magnet used by way of example. In combination, an ideal magnet system arises in terms of the ratio of mass or volume to field strength. In this regard, the situation is reversed in the case of volume or mass to price. NdFeB has become significantly more expensive in the meantime, for example, while ferrite magnets are very inexpensive and price-stable. The situation is similar for AlNiCo and Sm₂Co, which can be used instead of NdFeB according to the invention. With Sm₂Co or AlNiCo it would even be possible to produce multi-magnets according to the invention having high thermal stability.

However, there are even further points that express support for the use of the multi-magnet according to the invention, such as e.g. a distinctly better profile or better distribution of the field lines, and it is less sensitive to price fluctuations.

Precisely in the times of artificial shortage of raw materials and price manipulations thereof by speculations in the global markets, the prices in the raw-material sector for rare earths, cobalt, strontium, barium, boron, etc. have risen by more than 10-fold in the last 2 years.

A further improvement is afforded by the use of so-called short-circuiting rings, which are preferably arranged above and below the plane of the pole plates, or of additional caps or rings which surround or enclose the pole plate. Nonmagnetic materials, but with electrically highly conductive materials being the best, such as e.g. copper, brass, aluminum, etc., are used in both cases.

It is recommended to use the two short-circuiting rings in systems with relatively large amplitudes or movements, while the “cap” or the “ring” should rather be used in systems having small amplitudes or movements.

The mode of action of both types of rings is the same in principle. The intention is to prevent the static magnetic field in the air gap of the multi-magnet according to the invention from being disturbed or modulated by the alternating field of the oscillating coil through which there is a flow of AC voltage, since this can lead to considerably audible and measurable distortions in the case of use in loudspeakers.

To put it another way, the alternating field of the oscillating coil induces a current in the rings and the inductance of the oscillating coil is thereby reduced. The associated rise in impedance toward higher frequencies is virtually eliminated and the modulation of the magnetic field in the air gap is thus also virtually prevented.

Consequently, the multi-magnet system according to the invention constitutes the alternative to existing permanent magnet systems having not only a ring-shaped air gap.

In accordance with the above-described basic concepts of the invention, the inventor proposes the variants of the invention described below as particularly expedient embodiments:

AA) A magnet system comprising at least one permanent magnet unit, in particular for use in a loudspeaker, wherein the permanent magnet unit consists of an interconnected combination of at least a first permanent magnet having a first magnetic remanence and a second permanent magnet having a second magnetic remanence, wherein the second magnetic remanence is significantly greater than, preferably at least twice as great as, the first magnetic remanence.

AB) The magnet system in accordance with the embodiment variant AA), wherein the first permanent magnet is formed as a ferrite magnet and/or the second permanent magnet is formed as a rare earth magnet.

AC) The magnet system in accordance with one of the embodiment variants AA) or AB), wherein both permanent magnets are in each case formed rotationally symmetrically in a ring-shaped fashion and arranged coaxially about a common axis of symmetry.

AD) The magnet system in accordance with one of the embodiment variants AA) to AC), wherein both permanent magnets are connected to one another on one side via a return path.

AE) The magnet system in accordance with one of the embodiment variants AA) to AD), wherein the magnetization of both permanent magnets is formed in opposite directions relative to the common axis of symmetry.

AF) The magnet system in accordance with one of the embodiment variants AC) to AE), wherein both permanent magnets are magnetized simultaneously and in opposite directions relative to the common axis of symmetry in the assembled. state of the magnet system.

BA) A magnet system, in particular in accordance with the embodiment variant AA), wherein it comprises at least:
a first permanent magnet having a first magnetic remanence and a first pole plate connected thereto,
a second permanent magnet, having a second magnetic remanence, which is significantly higher than, preferably at least twice as high as, the first remanence of the first permanent magnet, and a second pole plate connected thereto,
a return path between the first permanent magnet and the second permanent magnet,
and an air gap for forming a high magnetic flux between the first pole plate and the second pole plate.

BB) The magnet system in accordance with the embodiment variant BA), wherein the magnet system is constructed rotationally symmetrically.

BC) The magnet system in accordance with one of the embodiment variants BA) to BB), wherein the first permanent magnet is a ferrite magnet.

BD) The magnet system in accordance with one of the embodiment variants BA) to BC), wherein the second permanent magnet is a rare earth magnet.

BE) The magnet system in accordance with one of the embodiment variants BA) to BD), wherein the return path has an L-shaped cross section, wherein each limb of the L is connected to one of the permanent magnets, such that a ring-shaped air gap arises between the first permanent magnet and the second permanent magnet including a limb of the L.

BF) The magnet system in accordance with one of the embodiment variants BA) to BE), wherein the pole plates are arranged concentrically with respect to one another and in each case on a permanent magnet, such that the air gap is formed between them.

BG) The magnet system in accordance with one of the embodiment variants BA) to BF), wherein the mass of the second permanent magnet has between 50% and 5%, preferably between 30% and 5%, preferably between 20% and 5%, preferably between 10% and 5%, of the mass of the first permanent magnet.

BH) The magnet system in accordance with one of the embodiment variants BA) to BG), wherein the second permanent magnet is a type of magnet from the following list: neodymium-iron-boron, barium ferrite, samarium cobalt, strontium ferrite, aluminum-nickel-cobalt.

BI) The magnet system in accordance with one of the embodiment variants BA) to BH), wherein the magnet system has a central opening.

BJ) The magnet system in accordance with one of the embodiment variants BA) to BI), wherein at least one short-circuiting ring comprising a nonmagnetic and electrically conductive material is arranged at at least one pole plate.

BK) The magnet system in accordance with one of the embodiment variants BA) to BJ), wherein at least one pole plate is at least partly covered by a short-circuiting cap or short-circuiting round plate, preferably open on the inner side.

BL) The magnet system in accordance with the embodiment variant BK), wherein the short-circuiting cap also covers the second permanent magnet at least partly toward the air gap.

CA) A magnetizing device for a magnet system, in particular for use in a loudspeaker, in particular in accordance with one of the embodiment variants AA) to BL), comprising:
a first magnet coil having a first yoke, which penetrates through the first magnet coil with one limb and comprises a second, open limb having two ends that form a first air gap,
a second magnet coil having a second yoke, which penetrates through the second magnet coil with one limb and forms a ring-shaped air gap by means of two ends that are formed in a ring-shaped fashion parallel to one another,
wherein the ends of the second yoke that are formed in a ring-shaped fashion in each case have a coaxial opening into which the ends of the first yoke engage, such that a common air gap arises, into which a magnet system to be magnetized in opposite directions can be inserted.

CB) The magnetizing device in accordance with the embodiment variant CA), wherein the first and second magnet coils are connected to at least one current/voltage supply in such a way that in the case of a simultaneous activation of the magnet coils in the common air gap a magnetic field in opposite directions is generated which is aligned oppositely in the gap of the first yoke in comparison with in the gap of the second yoke.

D) A method for producing a magnet system, in particular in accordance with one of the embodiment variants AA) to AF) or BA) to BL) and in particular using a magnetizing device in accordance with one of the embodiment variants CA) to CB), wherein the following production steps are carried out:
assembling a magnet system composed of a first and a second not yet premagnetized, in each case rotationally symmetrical permanent magnet, wherein the permanent magnets are arranged coaxially with respect to one another on different diameters with regard to their axis of symmetry and in a manner separated with respect to one another by an air gap,
inserting the magnet system into a magnetizing device, which can generate a magnetic field in each case simultaneously for each permanent magnet, wherein both magnetic fields are aligned axially in opposite directions,
simultaneously magnetizing the permanent magnets axially in opposite directions by momentarily switching on the magnetizing device,
removing the magnet system having permanent magnets magnetized axially in opposite directions.

E) A method for producing a magnet system, in particular in accordance with one of the embodiment variants AA) to AF) and using a magnetizing device, which generates in the interior a magnetic field aligned axially in the same basic direction (=not in opposite directions), wherein the following production steps are carried out:
assembling a magnet system composed of a first and a second not yet premagnetized, in each case rotationally symmetrical permanent magnet, wherein the permanent magnets are arranged coaxially with respect to one another on different diameters with regard to their axis of symmetry and in a manner separated with respect to one another by an air gap,
inserting the magnet system into the magnetizing device,
simultaneously magnetizing the two permanent magnets in a first axial alignment,
simultaneously applying to the two permanent magnets a magnetic field which is in opposite directions in the axial direction and has a field strength which does not reverse the magnetization of the first magnet, but reverses the magnetization of the second magnet in the opposite direction to its first magnetization,
removing the magnet system having axially oppositely magnetized permanent magnets.

FA) A method for producing a magnet system, in particular in accordance with one of the embodiment variants AA) to AF) and using a magnetizing device, which generates in the interior a magnetic field aligned axially in the same basic direction (=not in opposite directions), wherein the following production steps are carried out:
assembling a magnet system composed of a first and a second not yet premagnetized, in each case rotationally symmetrical permanent magnet, wherein the permanent magnets are arranged coaxially with respect to one another on different diameters with regard to their axis of symmetry and in a manner separated with respect to one another by an air gap,
inserting the magnet system into the magnetizing device,
simultaneously magnetizing the two permanent magnets in a first axial alignment,
shielding the first magnet by inserting an electrically conductive shield at least in the air gap,
simultaneously applying to the two permanent magnets a magnetic field which is in opposite directions in the axial direction and has a field strength that varies over time by momentarily switching on a magnet coil of the magnetizing device, wherein the magnetic field strength in the second, non-shielded magnet is lower than that in the first magnet,
removing the magnet system having axially oppositely magnetized permanent magnets.

FB) The method in accordance with the preceding embodiment variant FA), wherein after the first magnetizing and before the second magnetizing the first magnet is shielded by the insertion of an electrically conductive ring in the air gap or an electrically conductive cap that extends at least partly into the air gap.

FC) The method in accordance with the preceding embodiment variant FA), wherein after the first magnetizing and before the second magnetizing the first magnet an electrically conductive ring split in the axial direction is inserted in the air gap and the external magnetic field is attenuated by the supply of a current surge during the second magnetizing.

G) A method for producing a magnet system, in particular in accordance with one of the embodiment variants AA) to AF) and using a magnetizing device, which generates in the interior a magnetic field aligned axially in the same basic direction (=not in opposite directions), wherein the following production steps are carried out:
assembling a magnet system composed of a first and a second not yet premagnetized, in each case rotationally symmetrical permanent magnet, wherein the first permanent magnet has a saturation field strength which is less than the maximum field strength starting from which irreversible losses of the magnetization of the second permanent magnet arise,
inserting the magnet system into the magnetizing device,
simultaneously magnetizing the two permanent magnets in a first axial alignment with a field strength which is greater than the saturation field strength of the second permanent magnet,
subsequently simultaneously applying to the two permanent magnets a magnetic field which is in opposite directions in the axial direction and has a field strength which is greater than the saturation field strength and less than the maximum field strength starting from which irreversible losses of the magnetization of the second permanent magnet arise,
removing the magnet system having axially oppositely magnetized permanent magnets.

HA) A magnet system, in particular in accordance with the embodiment variant AA), wherein it comprises at least:
a first permanent magnet having a first magnetic remanence,
a second permanent magnet connected directly to the first permanent magnet and having a second magnetic remanence, which is significantly higher than, preferably at least twice as high as, the first remanence of the first permanent magnet,
a first pole plate, which is connected directly to the second permanent magnet,
a return path connected to the first permanent magnet,
and an air gap for forming a high magnetic flux between the return path and the first pole plate.

HB) The magnet system in accordance with the embodiment variant HA), wherein the magnet system is constructed rotationally symmetrically.

HC) The magnet system in accordance with one of the embodiment variants HA) to HE), wherein the first permanent magnet is a ferrite magnet.

HD) The magnet system in accordance with one of the embodiment variants HA) to HC), wherein the second permanent magnet is a rare earth magnet.

HE) The magnet system in accordance with one of the embodiment variants HA) to HD), wherein the mass of the second permanent magnet has between 50% and 5%, preferably between 30% and 5%, preferably between 20% and 5%, preferably between 10% and 5%, of the mass of the first permanent magnet.

HF) The magnet system in accordance with one of the embodiment variants HA) to HE), wherein the magnet system has a central opening.

HG) The magnet system in accordance with one of the embodiment variants HA) to HF), wherein at least one short-circuiting ring comprising a nonmagnetic and electrically conductive material is arranged at the pole plate.

HH) The magnet system in accordance with one of the embodiment variants HA) to HG), wherein the pole plate is at least partly covered by a short-circuiting cap or short-circuiting round plate, preferably open on the inner side.

HI) The magnet system in accordance with the embodiment variant HH), wherein the short-circuiting cap also covers the second permanent magnet at least partly toward the air gap.

I) A method for producing a magnet system, in particular in accordance with one of the embodiment variants AA) to AF) or HA) to HI) and in particular using a magnetizing device in accordance with one of the embodiment variants CA) to CB), wherein the following production steps are carried out:
assembling a magnet system composed of a first and a second not yet premagnetized, rotationally symmetrical permanent magnet and a return path formed in an L-shaped fashion in cross section, wherein the permanent magnets are arranged coaxially and one above another and are directly connected to one another, and an air gap is formed between the return path and the permanent magnets,
inserting the magnet system into a magnetizing device, which can generate a magnetic field in each case simultaneously for the permanent magnets, on the one hand, and the return path, on the other hand, wherein both magnetic fields are aligned axially in opposite directions and one magnetic field acts on the permanent magnets and one magnetic field acts on a limb of the return path,
simultaneously axially magnetizing the permanent magnets by momentarily switching on the magnetic fields of the magnetizing device that are in opposite directions,
removing the magnet system having the magnetized permanent magnets.

J) A magnet system, produced by a method described here, in particular according to a method in accordance with one of the embodiment variants D) G).

K) A loudspeaker comprising one of the magnet systems according to the invention as described here, wherein the magnet system was preferably magnetized and produced according to one of the magnetizing methods described here.

Instead of simultaneous magnetizing in opposite directions in a single magnetizing process, the two-phase magnetizing has proved to be particularly expedient, in which, in a first step, the multi-magnet system comprising two ring magnets arranged concentrically on different diameters, are separated by an air gap, are firstly magnetized in a common direction. Afterward, both ring magnets are oppositely magnetized in such a way that both ring magnets are exposed to the opposite magnetic field, but the polarity of only one magnet is reversed.

This can be done, for example, by choosing for the magnets in each case materials such that they have a significantly different coercivity and the second magnetizing in opposite directions is carried out with a field strength which reverses the polarity of one magnet but does not reverse the magnetization of the other magnet.

As an alternative to or as support for the first embodiment variant of magnetizing, by means of a shielding of one magnet during the second magnetizing in opposite directions, it is possible to reduce the magnetic field in the region of said one magnet such that no polarity reversal takes place, while the polarity of the other magnet is reversed. In this case, the shielding can take place by means of a conductive material in the air gap for which a counteracting ring current is induced in the case of a pulse-like magnetization reversal or a counteracting current pulse can be actively generated in the air gap during the magnetization reversal, said current pulse likewise manifesting an opposite effect.

The multi-magnet according to the invention will be explained here by way of example on the basis of a ring gap magnet for sound transducers.

The invention is described in greater detail below on the basis of preferred exemplary embodiments of a ring gap magnet for sound transducers with the aid of the figures, only the features necessary for understanding the invention being illustrated.

Specifically in the figures:

FIG. 1: shows a multi-magnet system comprising two concentrically arranged ring magnets having different remanences;

FIG. 2 shows the multi-magnet system from FIG. 1 in plan view;

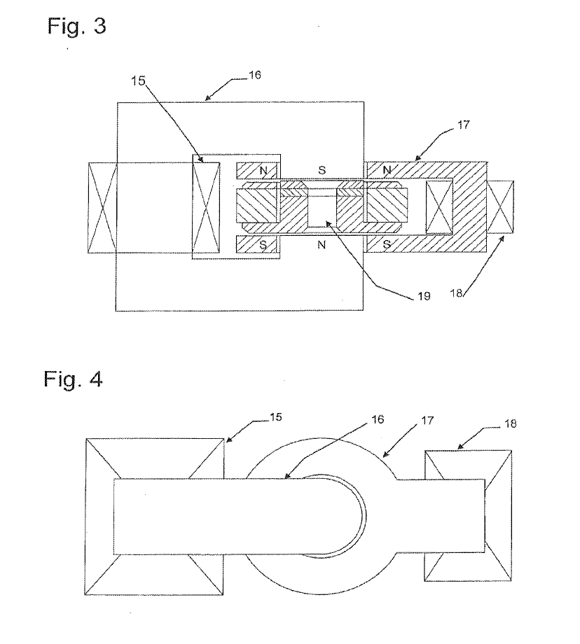

FIG. 3 shows a magnetizing device for simultaneous magnetizing in opposite directions in sectional view;

FIG. 4 shows the magnetizing device from FIG. 3 in plan view;

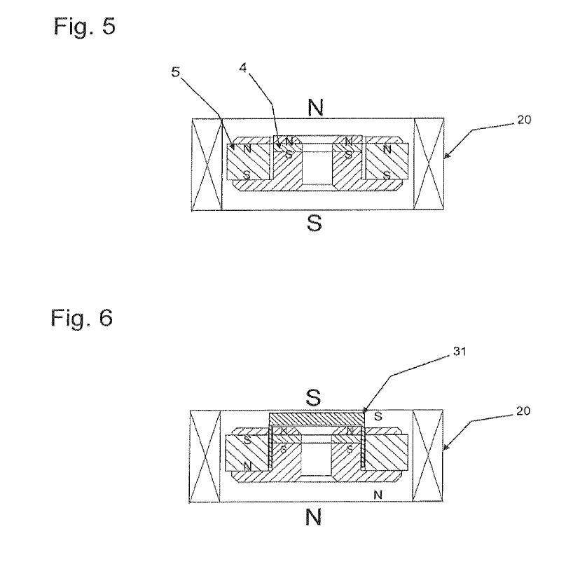

FIG. 5 shows a leakage field magnetizer with a magnet system in accordance with FIG. 1 in sectional view;

FIG. 6 shows a leakage field magnetizer with a magnet system in accordance with FIG. 1 with additional shielding in sectional view;

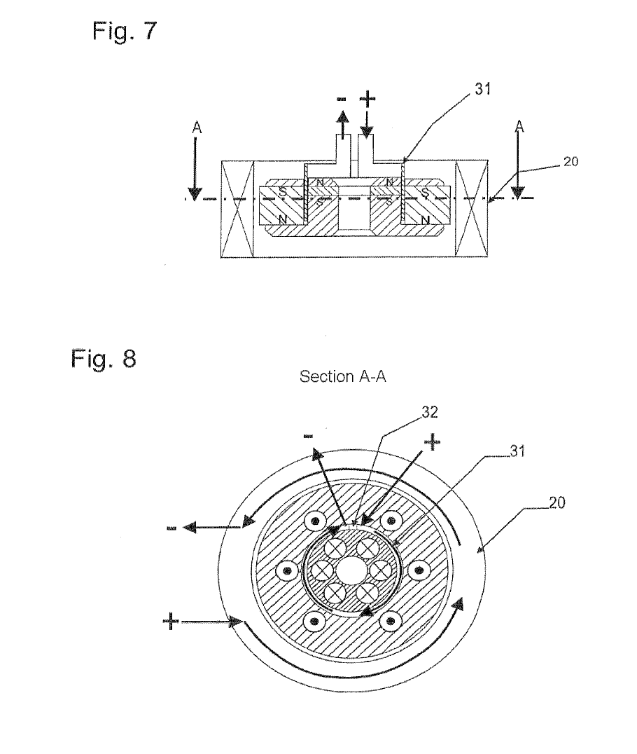

FIG. 7 shows a leakage field magnetizer with a magnet system in accordance with FIG. 1 with active shielding in sectional view;

FIG. 8 shows the leakage field magnetizer from FIG. 7 along section A-A;

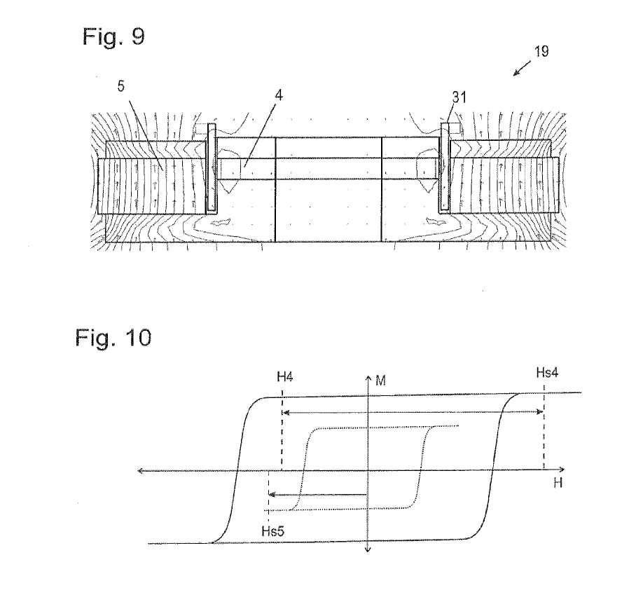

FIG. 9 shows the magnet system in accordance with FIG. 1 during the magnetizing in accordance with step II with shielding of the inner magnet;

FIG. 10 shows an illustration of the magnetizing in relation to an external magnetic field strength;

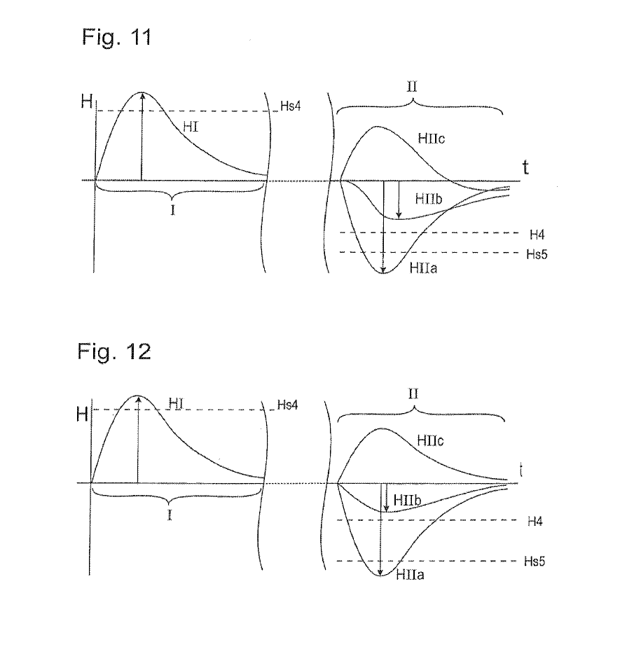

FIG. 11 shows a temporal field strength profile during steps I and II of magnetizing with passive shielding;

FIG. 12 shows a temporal field strength profile during steps I and II of magnetizing with active shielding;

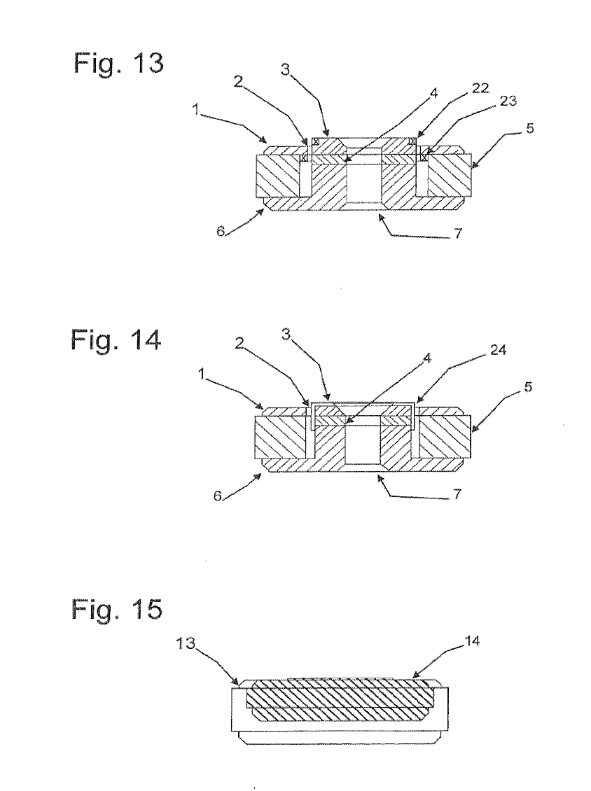

FIG. 13 shows an embodiment variant of the multi-magnet with a short-circuiting ring;

FIG. 14 shows an embodiment variant of the multi-magnet with a copper cap;

FIG. 15 shows a size comparison of a magnet system in accordance with the prior art and a multi-magnet according to the invention;

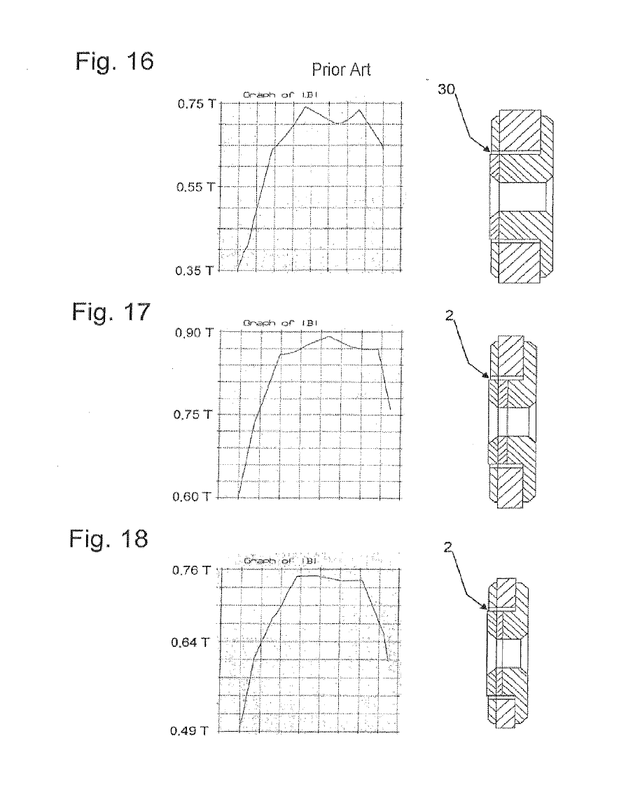

FIGS. 16-18 show a size comparison of the magnet systems in relation to the achievable field strength in the air gap;

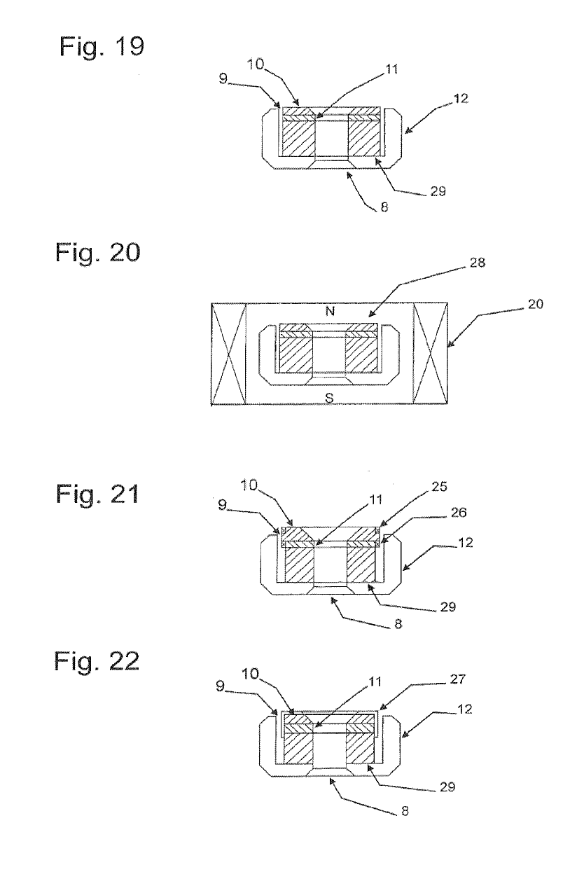

FIG. 19 shows a multi-magnet as a pot magnet system with a pot-like return path;

FIG. 20 shows a leakage field magnetizer with a magnet system according to FIG. 19;

FIG. 21 shows a multi-magnet as a pot magnet in the embodiment with two short-circuiting rings;

FIG. 22 shows a multi-magnet as a pot magnet in the embodiment with a short-circuiting cap.

FIG. 1 shows by way of example the multi-magnet according to the invention as a ring magnet system, with its outer pole plate 1, which is seated on the ferrite magnet 5 and preferably, but not necessarily, has a somewhat smaller internal diameter than the ferrite magnet. The air gap 2 then arises as a result of the internal diameter of the outer pole plate 1 relative to the external diameter of the inner pole plate 3, which is situated on the NdFeB magnet 4 used, for example, said magnet being situated in turn on the so-called T-yoke or yoke with return path 6, which also has an optional central hole 7 that can serve firstly for ventilation and secondly for better guidance of the field line profile in the air gap 2 of the system. In this case, it has proved to be particularly expedient, but not necessary, for the inner pole plate 3 to be embodied such that it is somewhat more projecting and higher than the outer pole plate 1.

Furthermore, it has proved to be particularly expedient for the external diameter of the inner pole plate 3 to be embodied such that it is greater than the diameters underneath of the NdFeB magnet 4 used, for example, and of the so-called T-yoke or yoke with return path 6. The phases preferably embodied at the edge of the pole plate 1 or depressions of the central or through hole serve, firstly, for improving the field line profile and, secondly, for preventing the evolution of noise as a result of displaced gaseous media, such as e.g. air, or through-flow of such media.

If the magnet volume and primarily the diameter (also applies to the variants according to FIGS. 11 & 12) in the core and air gap 2 and thus also the NdFeB magnet 4 used with its pole plate 3 are too small in a manner governed by the design, it may be advantageous not to use a central hole 7 with phases. A depression in the form of the phase, as in the case of the central hole 7, may nevertheless make sense, under certain circumstances, since even a depression in the pole plate 3 and return path 6 is concomitant with an improvement in the field line profile.

As a result of various experiments in the course of development, it has been found that, depending on the size and requirement of the system, it may be more expedient for the position of the NdFeB magnet 4 used, for example, in the region schematically depicted by way of example, also to be positioned centrally or further downward. In this case, the inner pole plate 3 would turn out to be correspondingly higher or even be able to be entirely omitted under specific conditions.

FIG. 2 shows in plan view the sectional indication of the multi-magnet according to the invention for FIGS. 1, 3, 5, 6, 7, 9, 12, 13, 16 and 17 for the sake of better understanding.

In particular, the concentric or coaxial arrangement of the two magnets having different coercivities 4 and 5 of the multi-magnet 19 is also clarified.

FIG. 3 shows by way of example the magnetizing device according to the invention of the multi-magnet 19 according to the invention in accordance with FIG. 1, said multi-magnet optionally being equipped e.g. with. NdFeB in the center. This device consists of an excitation coil 15, which can magnetize via a yoke 16 the central region and via a yoke 17—embodied in a ring-shaped fashion—and the excitation coil 18 thereof the outer region of the multi-magnet 19 according to the invention.

By means of the technology according to the invention or the multi-magnet according to the invention it is possible, then, that the magnets of the multi-magnet 19 according to the invention, although they consist of completely different material and normally each would have to be magnetized by itself, can be magnetized jointly. It is proposed that the coil 15, via its yoke 16, is magnetized the inner region with opposite polarity with greater than 2000 kA/m relative to the outer region, with the yoke 17 embodied in a ring-shaped fashion and the excitation coil 18 thereof with greater than 800 kA/m.

With this magnetizing device according to the invention, it is also possible to magnetize the multi-magnet according to the invention from FIG. 17 as a pot magnet system equipped e.g. with NdFeB and ferrite in the center. In this case, it is then also possible to use only the excitation coil 15 with the yoke 16 for the central region, greater than 2000 kA/m.

Since the yoke 16 and the yoke 17 cover the multi-magnet system 19 according to the invention only at the top and bottom and do not completely surround it, it is possible to integrate the magnetizing device according to the invention in a belt-like production line. In this case, the belt passes through the magnetizing device according to the invention in the region of the multi-magnet system 19 according to the invention, which securely receives the latter in a positively locking manner and in this case is also able to magnetize normal magnet systems since the coils 15 and 18 can also be operated separately and independently of one another.

FIG. 4 shows the magnetizing device according to the invention in plan view. The same reference signs as in FIG. 3 are used here.

As an alternative to the magnetizing of the magnet system from FIG. 1, or of one of the magnet systems from FIGS. 12 and 13, simultaneously in opposite directions, such a magnet system according to the invention can also be magnetized in opposite directions successively by means of a simple magnetizing coil. This procedure is described in greater detail in FIGS. 5 to 10.

FIG. 5 shows the magnet system 19 from FIG. 1 in a magnetizing coil 20. By this means, in a first step, the entire magnet system 19 comprising the two magnets 4 and 5 arranged concentrically on different diameters is magnetized in a common N-S direction. In this case, the magnet 4 having higher coercivity is fully magnetized by an axial field arrangement, and the magnet 5 having low coercivity is partly or fully magnetized in the same direction. The magnetizing direction of the magnetizing device and of the magnets is described by the designation N and S.

Alternatively the axial field can also be realized by a yoke similar to FIG. 3, or by the central or leakage field of an axial field coil according to FIG. 8. Moreover, the magnetizing coil can also additionally have a return path.

FIG. 6 describes the second step of magnetizing, wherein the magnet 5 is magnetized in the opposite direction. For this purpose, the magnetizing coil 20 is operated with an inverted field direction relative to FIG. 5. In this case, however, the magnetization of the already magnetized magnet 4 must not be reversed.

This can take place, on the one hand, through the use of a magnet material of correspondingly high coercivity for the magnet 4; such that the latter has in this way a higher resistance to reversal of magnetization than the magnet 5. In this case, a field is applied which, although it reverses the magnetization of the magnet 5, does not alter the magnetization of the magnet 4 on account of its higher coercivity.

Alternatively, a shield 31 composed of a material having good electrical conductivity (e.g. copper) can be introduced into the air gap of the magnet system between the magnets 4 and 5. Said shield 31 can be formed as a cap, but at least as a ring.

As a result of the coil 20 being energized for a short period, eddy currents are generated in the ring, said eddy currents displacing the inverse field for the magnet 4 and amplifying the field for reversing the magnetization of the magnet 5. In this way, the magnetization direction of the magnet 5 is inverted, while the magnetization of the magnet 4 is maintained.

As can be discerned on the basis of the entered magnetization alignments N and S, the magnetization of the magnets 4 and 5 runs in opposite directions after the second step.

A further variant of the second step of the magnetizing according to the invention is shown in FIGS. 7 and 8. Here, instead of the passive magnetic field attenuation by means of a conductive ring in the air gap of the multi-magnet or a corresponding conductive cap, an actively energized ring 31 split by the gap 32 in the axial direction is inserted into the air gap between the magnets 4 and 5 and upon the switch-on of the external inverted magnetic field by means of the magnetizing coil 20 is subjected to current in such a way that a magnetic field counteracting the external magnetic field of the magnetizing device arises. This internal magnetic field then brings about a reduction of the field strength of the external magnetic field and prevents the reversal of the magnetization of the magnet 4, while it fosters the reversal of the magnetization of the magnet 5.

FIG. 7 shows the magnetizing coil 20 with the multi-magnet arranged therein in axial sectional view, while FIG. 8 shows the section A-A through the coil 20.

As illustrated in FIG. 8, at the instant of the reversal of the magnetization of the magnet 5 by application of voltage to the split ring 31, a current is generated in the air gap and in turn generates a magnetic field—represented by six arrows emerging from the area of the drawing outside the ring 31 and the six arrows entering the area of the drawing within the ring 31—which fosters the reversal of the magnetization of the outer magnet 5, but counteracts the reversal of the magnetization of the magnet 4 lying within the ring 31.

In the case of the above-described reversal of the magnetization in the second step with an oppositely directed, actively generated magnetic field, the current pulse through the ring has to be synchronized temporally with the current through the outer coil. In this case, it is possible, depending on the size of the magnet system, to step up the ring current by means of a current transformer or to connect it in series with the outer coil.

In order to clarify the magnetic field present in the magnet system 19 during the reversal of the magnetization of the outer magnet 5, that is to say during the second step, FIG. 9 once again shows the multi-magnet 19 in sectional view, the magnetic field directions and the magnetic field lines additionally being shown. It can be discerned that the ring 31 used and the ring current that arises there attenuates the external magnetic field in the magnet 4 and amplifies the external magnetic field in the magnet 5. Correspondingly, the magnet 5 is aligned oppositely, while the magnet 4 maintains its magnetization direction initially impressed in the first step.

In this respect, FIG. 10 additionally plots the magnetization M in relation to an outer magnetizing field strength H in the form of a hysteresis loop for two different materials—corresponding to the magnets 4 and 5. By way of example, the magnet 4 can correspond to the solid profile, where the magnetization in the magnet 4 remains up to a field strength H of greater than H4, while thereafter a permanent attenuation through to polarity reversal of the magnetization commences. The profile of the magnetization M for a material of the magnet 5 is correspondingly shown in a dotted manner. In this way, in principle two magnets having different coercivities can be oppositely polarized alongside one another with the same magnetic fields taking effect.

If Hs5<H4, then no shield is required for the magnet 4 in the second step.

According to the invention, the selection of the magnet materials with regard to the ratio of Hs5 to H4 is extended by virtue of the fact that the magnet 4 whose polarity is not to be reversed is additionally shielded—passively or actively—against the magnetic field effecting the magnetization reversal.

Such a process is clarified in FIGS. 11 and 12 by the plotting of the field strength H that takes effect against the time axis t.

FIG. 11 shows steps I and II of the magnetizing by a magnetizing device in accordance with FIGS. 5 and 6 with passive shielding. In step I, the two magnets 4 and 5 are subjected to an approximately identical field strength profile HI and, in a manner mounted alongside one another, are magnetized in the same N-S direction. Afterward, between the first step I and the second step II of the magnetizing according to the invention, a shielding ring or a shielding cap is placed into the air gap between the magnets 4 and 5. This is then followed by step II, which involves generating an oppositely directed magnetic field with the profile HIIa in the magnetizing coil. This field also acts on the unprotected magnet 5 and completely reverses the polarity thereof, since it is greater than the saturation field strength Hs5 thereof. At the same time, however, only a field strength profile in accordance with HIIb is applied to the magnet 4 lying within the shield, since the ring current generated in the shield counteracts the external magnetic field in the form of HIIc. The field strength profile of the magnetic field thus generated, HIIb=HIIa-HIIc, remains below the limit of H4. Accordingly, the magnet 4 is not attenuated and both magnets maintain their oppositely directed, fully saturated magnetization in the already assembled state.

FIG. 12 shows steps I and II according to the invention of the magnetizing by a magnetizing device in accordance with FIG. 5 and 7 or 8 with active shielding. In step I, the two magnets 4 and 5 are subjected to an approximately identical field strength profile HI and, in a manner mounted alongside one another, are magnetized in the same N-S direction. Afterward, between the first step I and the second step II of the magnetizing according to the invention, an actively energizable ring is placed into the air gap between the magnets 4 and 5, as is shown in FIGS. 7 and 8. This is then followed by step II, which involves generating an oppositely directed magnetic field with the profile HIIa in the magnetizing device. This field acts on the unprotected magnet 5 and completely reverses the polarity thereof, since it is greater than Hs5. At the same time, however, voltage is applied to the ring 31 and a ring current is generated in the air gap, which ring current generates an oppositely directed field strength profile in accordance with HIIc and leads to a field strength profile HIIb within the magnet 4. Since the magnetic field generated within the shield remains below the limit of H4, the magnet 4 is not attenuated and both magnets maintain their oppositely directed, fully saturated magnetization in the already assembled state, as is shown in FIG. 7.

Further embodiments according to the invention of a multi-magnet are shown in FIGS. 13 and 14. FIG. 13 shows the multi-magnet according to the invention in the embodiment with two short-circuiting rings 22—above and in the outer edge of the inner pole plate 3—and 23—below the outer pole plate 1. The short-circuiting rings 22 and 23 preferably consist of aluminum, copper or brass. However, it is also possible for the short-circuiting ring 22 to be situated above the outer pole plate 1 and thus to have inner and outer diameters the same as or similar to those of the short-circuiting ring 23.

FIG. 14 shows the multi-magnet according to the invention in the embodiment with the so-called copper cap 24, which can optionally consist of aluminum, copper or brass. In this example, it encloses the yoke of the return path 6 or T-yoke, with the optionally inserted NdFeB magnet 4 and the inner pole plate 3 thereof. In this case, the copper cap preferably also has a hole corresponding to the through hole 7 with phases. However, it is also conceivable for the copper cap 24 to be embodied as a ring which only encloses the inner pole plate 3 or covers it slightly over the height downward and upward.

FIG. 15 show the possible saving in size of the multi-magnet system according to the invention in comparison with a conventional ferrite magnet system. The reference sign 13 denotes a magnet system equipped exclusively with ferrite magnets, while the reference sign 14 (hatched area) represents the same magnet system, but with the combination according to the invention of different magnet types, in cross section.

FIGS. 16 to 18 show a size comparison of the magnet systems in relation to the achievable field strength in the air gap.

FIG. 16 shows a standard ferrite magnet with its field strength profile as measured in the over the thickness in the ring-shaped air gap 30.

FIG. 17 shows an optimized multi-magnet according to the invention in accordance with FIG. 1, said multi-magnet already being reduced by one quarter in height or thickness, for example with an NdFeB magnet 4 and a thinner ferrite magnet 5, with an inner pole plate 3 and an outer pole plate 1 and its field strength profile, as measured in the over the thickness in the ring-shaped air gap 2. A significantly higher and primarily more linear profile than in the case of the curve in FIG. 16 is evident here.

FIG. 18 shows an extensively optimized multi-magnet according to the invention in accordance with FIG. 1, for example with an even thinner NdFeB magnet 4 and ferrite magnet 5, with an inner pole plate 3 and an outer pole plate 1 and its field strength profile, as measured in the over the thickness in the ring-shaped air gap 2. The aim here was to generate approximately the field of the same strength as in FIG. 8. In this case, it is evident that the profile still proceeds significantly more linearly and somewhat higher than in the case of the standard magnet in FIG. 8. This is achieved even though only half of the volume and mass of magnetic material is used.

In accordance with the fundamental concept of the invention, according to which a reduction in the size of the magnet system, in particular for a loudspeaker, is achieved by means of a permanent magnet unit composed of an interconnected combination of at least a first permanent magnet having a first magnetic remanence and a second permanent magnet having a second magnetic remanence, wherein the second magnetic remanence is significantly greater than, preferably at least twice as great as, the first magnetic remanence, a different variant of a magnet system according to the invention is shown in the subsequent FIGS. 19-22.

FIG. 19 shows by way of example the multi-magnet according to the invention as a pot magnet system, with the pot-like return path 12. The air gap 9 then arises as a result of the internal diameter of the pot-like return path 12 relative to the external diameter of the pole plate 10, which is situated on the NdFeB magnet 11 used, for example, said magnet in turn being situated on the ferrite magnet 29, which also has an optional central hole 8 that can serve, firstly, for ventilation and, secondly, for better guidance of the field line profile in the air gap 9 of the system. In this case, it has proved to be particularly expedient to embody the pole plate 10 such that it is somewhat more projecting and/or higher than the height of the pot-like return path 12.

If the magnet volume and primarily the diameter in the core and air gap 9 and thus also the NdFeB magnet 11 used with its pole plate 10 are too small in a manner governed by the design, it may be advantageous not to use a central hole 8 with phases. A depression in the form of the phase, as in the case of the central hole 8, may nevertheless make sense, under certain circumstances, since even a depression in the pole plate 10 and pot-like return path 12 is concomitant with an improvement in the field line profile.

Furthermore, it has proved to be particularly expedient for the external diameter of the pole plate 10 to be embodied such that it is greater than the diameter underneath of the NdFeB magnet 11 used, for example, and of the ferrite magnet 29. The phases preferably embodied at the edges of the pot-like return path 12 or depressions of the central or through hole serve, firstly, for improving the field line profile and, secondly, for preventing the evolution of noise as a result of displaced gaseous media, such as e.g. air, or through-flow of such media.

Depending on the size and requirement of the system, it may also be more expedient to turn around the position of the NdFeB magnet 11 and ferrite magnet 29 used, for example, in the region depicted schematically, for example, to position the latter centrally or to position both magnets further toward the bottom. In this case, the pole plate 10 would turn out to be correspondingly higher or even be able to be entirely omitted under specific conditions.

FIG. 20 shows a magnetizing device such as has already been shown in FIGS. 5 to 8, in an embodiment as a leakage-field-magnetizing coil 20, with which the magnet system according to the invention in accordance with FIG. 19 can also be magnetized, which is optionally equipped e.g. with NdFeB and ferrite in the center, and is formed as a pot magnet system. In this case, a leakage field of greater than 2000 kA/m should be used for magnetizing purposes.

FIG. 21 shows a multi-magnet according to the invention as a pot magnet in the embodiment with two short-circuiting rings 25—above and in the outer edge of the pole plate 10—and 26—enclosing below the NdFeB magnet 11 used for example. The short-circuiting rings 25 and 26 preferably consist of aluminum, copper or brass. However, it is also possible that the short-circuiting ring 25 can be situated above or on the edge of the pot or return path 12.

FIG. 22 shows the multi-magnet according to the invention as a pot magnet system in the embodiment with the so-called copper cap 27, which can optionally consist of aluminum, copper or brass. In this example, it encloses the ferrite magnet 29, the NdFeB magnet 11 optionally used, and its pole plate 10. Preferably, in this case, the copper cap also has a hole corresponding to the through hole 8 with phases. Here, too, it is possible for the copper cap 27 to be embodied as a ring that only encloses the pole plate 10 or covers it slightly over the height downward and upward.

If the magnet volume and primarily the diameter in the core and air gap 2 and thus also the NdFeB magnet 11 used with its pole plate 10 are too small in a manner governed by the design, it may be advantageous not to use a central hole 8 with phases. A depression in the form of the phase, as in the case of the central hole 8, may nevertheless make sense, under certain circumstances, since even a depression in the pole plate 10 and pot-like return path 12 is concomitant with an improvement in the field line profile.

Overall, the invention therefore proposes a magnet system comprising at least one permanent magnet unit, in particular for use in a loudspeaker, wherein the permanent magnet unit consists of an interconnected combination of at least a first permanent magnet having a first magnetic remanence and a second permanent magnet having a second magnetic remanence, and the second magnetic remanence is significantly greater than, preferably at least twice as great as, the first magnetic remanence.

Furthermore, the invention relates to a magnetizing device for such a magnet system which, with the aid of two yoke systems that can be operated simultaneously by means of separate coils, can set up two magnetic fields aligned parallel and oppositely, wherein the first magnetic field concentrically encloses the second magnetic field in the manner that a thick cylinder jacket concentrically encloses an inner cylinder.

Moreover, the invention relates to a method for producing and magnetizing the abovementioned magnet system with the abovementioned magnetizing device, and a loudspeaker comprising a magnet system according to the invention.

Although the invention has been more specifically illustrated and described in detail by means of the preferred exemplary embodiment, nevertheless the invention is not restricted by the examples disclosed and further variations can be derived therefrom by the person skilled in the art, without departing from the scope of protection of the invention.

### LIST OF REFERENCE SIGNS

1 Outer pole plate
2 Air gap
3 Inner pole plate
4 NdFeB magnet
5 Ferrite magnet
6 Return path
7 Central hole/central opening/through hole
8 Central hole/central opening/through hole
9 Air gap
10 Pole plate
11 NdFeB magnet
12 Return path
13 Magnet system in accordance with the prior art
14 Magnet system according to the invention
15 Coil
16 Yoke
17 Yoke
18 Coil
19 Multi-magnet
20 Leakage-field-magnetizing coil
22 Short-circuiting ring
23 Short-circuiting ring
24 Copper cap
25 Short-circuiting ring
26 Short-circuiting ring
27 Copper cap
28 Multi-magnet
29 Ferrite magnet
30 Air gap
31 Shield/ring/cap
32 Gap
I First step of magnetizing
II Second step of magnetizing
H Magnetic field strength
H4, H5 Maximum field strength starting from which the magnets 4 and 5 irreversible losses of the magnetizing arise
Hs4, Hs5 Saturation field strength of the magnets 4 and 5 starting from which complete magnetizing occurs
HI Profile of the magnetic field strength in step I
HIIa Profile of the magnetic field strength in step II in a first magnet
HIIb Profile of the magnetic field strength in step II in a second magnet
HIIc Profile of the magnetic field strength in step II as a result of induced ring current
M Magnetization

1-14. (canceled)

15. A magnet system comprising at least one permanent magnet unit wherein the permanent magnet unit comprises an interconnected combination of at least a first permanent magnet having a first magnetic remanence and a second permanent magnet having a second magnetic remanence, wherein the second magnetic remanence is significantly greater than the first magnetic remanence.

16. A magnet system as claimed in claim 15, comprising:
a first permanent magnet having a first magnetic remanence and a first pole plate connected thereto,
a second permanent magnet, having a second magnetic remanence, which is significantly higher than the first remanence of the first permanent magnet, and a second pole plate connected thereto,
a return path between the first permanent magnet and the second permanent magnet,
and an air gap for forming a high magnetic flux between the first pole plate and the second pole plate.

17. A magnetizing device comprising:
a first magnet coil having a first yoke, which penetrates through the first magnetic coil with one limb and comprises a second, open limb having two ends that form a first air gap,
a second magnet coil having a second yoke, which penetrates through the second magnet coil with one limb and forms a ring-shaped air gap between two ends that are formed in a ring-shaped fashion parallel to one another,
wherein the ends of the second yoke that are formed in a ring-shaped fashion in each case have a coaxial opening into which the ends of the first yoke engage, such that a common air gap arises, into which a magnet system to be magnetized in opposite directions can be inserted.

18. A method for producing a magnet system comprising the steps:
assembling a magnet system comprising a first and a second not yet premagnetized, in each case rotationally symmetrical permanent magnet, wherein the permanent magnets are arranged coaxially with respect to one another on different diameters with regard to their respective axis of symmetry and in a manner separated with respect to one another by an air gap,
inserting the magnet system into the magnetizing device as claimed in claim 17, which can generate a magnetic field in each case simultaneously for each permanent magnet, wherein both magnetic fields are aligned axially in opposite directions,
simultaneously magnetizing the permanent magnets axially in opposite directions by momentarily switching on the magnetizing device, and
removing the resulting magnet system from the magnetizing device, having permanent magnets magnetized axially in opposite directions.

19. A method for producing a magnet system comprising the steps of:
assembling a magnet system comprised of a first and a second not yet premagnetized, in each case rotationally symmetrical permanent magnet, wherein the permanent magnets are arranged coaxially with respect to one another on different diameters with regard to their respective axis of symmetry and in a manner separated with respect to one another by an air gap,
inserting the magnet system into the magnetizing device as claimed in claim 17,
simultaneously magnetizing the two permanent magnets in a first axial alignment,
simultaneously applying to the two permanent magnets a magnetic field which is in opposite directions in the axial direction and has a field strength which does not reverse the magnetization of the first magnet, but reverses the magnetization of the second magnet in the opposite direction to its first magnetization, and
removing the resulting magnet system from the magnetizing device, having axially oppositely magnetized permanent magnets.

20. A method for producing a magnet system comprising the steps of:
assembling a magnet system comprised of a first and a second not yet premagnetized, in each case rotationally symmetrical permanent magnet, wherein the permanent magnets are arranged coaxially with respect to one another on different diameters with regard to their axis of symmetry and in a manner separated with respect to one another by an air gap,
inserting the magnet system into the magnetizing device as claimed in claim 17,
simultaneously magnetizing the two permanent magnets in a first axial alignment,
shielding the first magnet by inserting an electrically conductive shield at least in the air gap,
simultaneously applying to the two permanent magnets a magnetic field which is in opposite directions in the axial direction and has a field strength that varies over time by momentarily switching on a magnet coil of the magnetizing device, wherein the magnetic field strength in the second, non-shielded magnet is lower than that in the first magnet,
removing the resulting magnet system from the magnetizing device, having axially oppositely magnetized permanent magnets.

21. The method as claimed in claim 18, wherein after the first magnetizing and before the second magnetizing the first magnet is shielded by the insertion of an electrically conductive ring in the air gap or an electrically conductive cap that extends at least partly into the air gap.

22. The method as claimed in claim 18, wherein after the first magnetizing and before the second magnetizing the first magnet an electrically conductive ring split in the axial direction is inserted in the air gap and the external magnetic field is attenuated by the supply of a current surge during the second magnetizing.

23. A method for producing a magnet system comprising the steps of:
assembling a magnet system comprised of a first and a second not yet premagnetized, in each case rotationally symmetrical permanent magnet, wherein the first permanent magnet has a saturation field strength (Hs5) which is less than the maximum field strength (H4) starting from which irreversible losses of the magnetization of the second permanent magnet arise,
inserting the magnet system into the magnetizing device as claimed in claim 17,
simultaneously magnetizing the two permanent magnets in a first axial alignment with a field strength which is greater than the saturation field strength (Hs4) of the second permanent
subsequently simultaneously applying to the two permanent magnets a magnetic field which is in opposite directions in the axial direction and has a field strength which is greater than the saturation field strength (Hs5) and less than the maximum field strength (H4) starting from which irreversible losses of the magnetization of the second permanent magnet arise,
removing the resulting magnet system from the magnetizing device, having axially oppositely magnetized permanent magnets.

24. A magnet system as claimed in claim 15, comprising:
a first permanent magnet having a first magnetic remanence,
a second permanent magnet connected directly to the first permanent magnet and having a second magnetic remanence, which is significantly higher than the first remanence of the first permanent magnet,
a first pole plate, which is connected directly to the second permanent magnet,
a return path connected to the first permanent magnet,
and an air gap for forming a high magnetic flux between the return path and the first pole plate.

25. A method for producing a magnet system comprising the steps of:
assembling a magnet system comprised of a first and a second not yet premagnetized, rotationally symmetrical permanent magnet and a return path formed in an L-shaped fashion in cross section, wherein the permanent magnets are arranged coaxially and one above another and are directly connected to one another, and an air gap is formed between the return path and the permanent magnets,
inserting the magnet system into a magnetizing device as claimed in claim 17, which can generate a magnetic field in each case simultaneously for the permanent magnets, on the one hand, and the return path, on the other hand, wherein both magnetic fields are aligned axially in opposite directions and one magnetic field acts on the permanent magnets and one magnetic field acts on a limb of the return path,
simultaneously axially magnetizing the permanent magnets by momentarily switching on the magnetic fields of the magnetizing device that are in opposite directions, and
removing the resulting magnet system from the magnetizing device, having the magnetized permanent magnets.

26. The magnetic system as claimed in claim 15, wherein the second magnetic remanence is at least force as great as the first magnetic remanence.

27. The magnetic system as claimed in claim 16, wherein the second magnetic remanence is at least force as great as the first magnetic remanence.

28. A loudspeaker comprising a magnet system as claimed in claim 15.

29. The method as claimed in claim 19, wherein after the first magnetizing and before the second magnetizing the first magnet is shielded by the insertion of an electrically conductive ring in the air gap or an electrically conductive cap that extends at least partly into the air gap.

30. The method as claimed in claim 19, wherein after the first magnetizing and before the second magnetizing the first magnet an electrically conductive ring split in the axial direction is inserted in the air gap and the external magnetic field is attenuated by the supply of a current surge during the second magnetizing.

31. The method as claimed in claim 20, wherein after the first magnetizing and before the second magnetizing the first magnet is shielded by the insertion of an electrically conductive ring in the air gap or an electrically conductive cap that extends at least partly into

32. The method as claimed in claim 20, wherein after the first magnetizing and before the second magnetizing the first magnet an electrically conductive ring split in the axial direction is inserted in the air gap and the external magnetic field is attenuated by the supply of a current surge during the second magnetizing.
